(19) United States
(12) Patent Application Publication
(10) Pub. No.: US 2009/0229140 A1
(43) Pub. Date: Sep. 17, 2009

(54) METHOD OF DRYING SLUDGE AND DEVICE FOR IMPLEMENTING THE METHOD

(75) Inventor: Bernard Dedieu, Olivet (FR)

Correspondence Address: PERMAN & GREEN, 425 POST ROAD, FAIRFIELD, CT, 06824, US

(73) Assignees: Arthur Barbosa, Vienne en Val (FR); BEARN INNOVATION, Saran France (FR); SARL INNOPARTS, Chaingy (FR)

(21) Appl. No.: 12/297,903

(22) PCT Filed: Apr. 20, 2007
(86) PCT No.: PCT/FR2007/000671

§ 371 Date: Jan. 13, 2009

(30) Foreign Application Priority Data
Apr. 21, 2006 (FR) 0603551

(51) Int. Cl. F26B 3/34

(52) U.S. Cl. 34/259

(57) ABSTRACT

A method and device for the drying of sludges, wherein the drying method includes a stage for raising a sealed enclosure to a set pressure, at least by the injection of saturating water vapour, and for holding this pressure for a given length of time; a stage for loading the sludges into a tank that is distanced from the walls of the enclosure, with loading means that guarantee maintenance of the pressure; a stage for the injection of superheated steam into the sludge by means of a mixer in action close to the wall of the tank that is most distant in relation to the source of the microwaves, including injection means; a stage for heating to the centre of the sludge by the emission of microwaves at frequencies of between 400 and 2450 MHz in the direction of the tank, this stage being executed while mixing the sludge; a stage for removal of the water collected by condensation and run-off on the walls of the enclosure toward the bottom of the enclosure, by means of a valve leading to the outside.

### CROSS REFERENCE TO RELATED APPLICATIONS

This application is the National Stage of International Application No. PCT/FR2007000671, International Filing Date, 20 Apr. 2007, which designated the United States of America, and which International Application was published under PCT Article 21 (2) as WO Publication No. WO2007/122328 and which claims priority from French Application No. 0603551, filed on 21 Apr. 2006, the disclosures of which are incorporated herein by reference in their entireties.

### BACKGROUND

1. Field

This disclosed embodiments concern a method for the drying of sludges, and the device used to implement the method, and more particularly a method and its device for the drying of industrial, mixed or urban sludges.

2. Brief Description of Related Developments

The problem set by the treatment of the sewage sludges is a problem that very seriously preoccupies local and state authorities. In fact their quantity is increasing steadily, and the risks of toxic, bacteriological and olfactory pollution that they cause for the soil, the ground water and the environment are also on the rise. It is therefore necessary to be in possession of an optimal technique for the treatment and re-use of these sludges that is reliable, sustainable, ecological, economic, and applicable to all cases.

In order to deal with these problems, there currently exist several solutions for the treatment of sludges.

One can mention in particular the treatments by convection, whose principle is based on the transfer of heat. The drawback of this technique is that it is very costly.

Another solution consists of drying the sludges in a first stage, and then putting them into the form of granules that can be stored.

In general, the drying stage is effected by placing the sludges, still wet, on a drying bed, after which the sludge is then swept with a stream of heated air. At the end of this stage the sludges are converted into granule form.

A drawback of this type of treatment is that this drying of sludges with heated airflow is too lengthy.

Patent FR 2 115 951 proposes a device, which could solve the problem of the excessively long drying time, that is used to dry foodstuff type products for animals or fertiliser, and that is used to sterilise these products, after first putting them into the form of fragmented sludges. This device includes a worm feed in the form of a tube that will allow transportation of the fragmented sludges. The transportation includes a shaft lying axially in relation to the tube and including vanes arranged in a helix. This transportation device has as its single aspect to move forward the fragmented sludges toward the zone where they will be treated by microwaves. The function of the microwaves is to effect sterilisation of the fragments and to finish off the drying by allowing the release of the remaining water from the fragmented sludges. The quantities thus dried exit from the device and are collected for packaging.

The drawback of this device is that it necessitates several stages to complete the drying of the products, and in particular a stage for fragmentation of the sludges to be dried. These various stages require equipment that is more complex and more bulky.

Another drawback of these drying devices is that in certain cases, risks that fire or explosion may occur can arise. The risks of explosion exist if three factors are present, namely a high dust content, a high oxygen content and a source of ignition. It is therefore important to avoid the presence of any one of these three factors.

Moreover, the devices using these techniques are expensive and their use is costly in energy terms.

When the drying is performed correctly, the dried sludge can heat spontaneously giving rise to a source of ignition. This ignition factor is therefore often present during the drying of sludges. It is therefore necessary to take steps to avoid the presence of the other two factors, namely the dust and the oxygen content.

### SUMMARY

The purpose of the disclosed embodiments is to propose a method and a device than can be used to optimise the drying of sludges without a risk of explosion, while also very rapidly achieving complete drying of the sludges and therefore reducing the energy consumed.

This aspect is met by the fact that the sludge drying method, as used for sewage sludges, liquid manure or the output from septic tanks, includes:

a stage for the raising to a set pressure of a sealed enclosure at least by injection of saturating water vapour, and for holding this pressure for a given length of time;

a stage for loading the sludges into a tank that is distanced from the walls of the enclosure, with loading means that guarantee maintenance of the pressure;

a stage for the injection of superheated steam into the sludge by means of a mixer in action close to the wall of the tank that is most distant in relation to the source of the microwaves, including the injection means;

a stage for heating to the centre of the sludge by the emission of microwaves at frequencies of between 400 and 2450 MHz in the direction of the tank, with this stage executed white mixing the sludge;

a stage for removal of the water collected by condensation and run-off on the walls of the enclosure toward the bottom of the enclosure, by means of a valve leading to the outside.

According to another particular feature, during the whole drying period, the sludge is mixed, with the mixer, in order to achieve greater homogeneity of the drying process, while also considerably favouring the penetration of the microwaves into the material.

According to another particular feature, the water vapour saturating pressure is in a range between 1 bar and 3 bars.

According to another particular feature, the water vapour saturating pressure is 1 bar.

According to another particular feature, the superheated steam pressure is between 1 bar and 5 bars.

According to another particular feature, the superheated steam pressure is 3 bars.

According to another particular feature, the temperature of the enclosure must be less than the temperature of the sludge in order to allow evaporation.

According to another particular feature, the irradiation by the microwaves is effected when the temperature of the sludge is between 110° C. and 140° C.

According to another particular feature, the irradiation by the microwaves is effected when the temperature of the sludge is 130° C.

Another aspect of the disclosed embodiments is to propose a device that is used to implement the method.

This aspect is met by the fact that the device used to implement the method is composed of an enclosure that includes a sealed tank that is resistant to the pressure, and communicating by at least one window in quartz crystal or any other material suitable for use with microwaves, with at least one microwave generator, where the enclosure communicates with a saturating steam arrival path and an input of the sludge to be dried, a mixer including means for the injection of superheated steam, placed in the enclosure, and an opening for unloading the dried materials.

According to another particular feature, at its lowest part the device includes an orifice oriented toward the ground that is used to remove the run-off water, by gravity, controlled by a valve or to regulate the internal pressure of the enclosure.

According to another particular feature, the enclosure includes refrigerating means placed at its lowest part so as to cool its internal wall in contact with the pressurised atmosphere, with the means being placed so as to cool only part of the enclosure.

According to another particular feature, the refrigerating means are used to cool between half and three quarters of the enclosure.

According to another particular feature, the mixer is formed from a tube that includes at least one mixer element of vane type attached to its periphery, with the injection means being placed on this element.

According to another particular feature, the tube is connected to a superheated steam generator, with the steam produced by the generator flowing in the tube until it arrives at the mixer element, and then is being injected by the injection means.

According to another particular feature, the injection means are formed by openings formed on the mixer element.

According to another particular feature, all the openings of the enclosure are capable of being plugged by plugging means to set up the sealing conditions against the pressure and to the microwaves.

According to another particular feature, the enclosure includes refrigerating means that is used to cool a part of its inside surface in order to favour condensation of the water evaporated by the drying treatment.

According to another particular feature, the device includes at least one end that can be closed off by an automatic door to set up the sealing conditions against the pressure and to the microwaves.

According to another particular feature, the microwave generator communicates with the drying enclosure through a microwave coupler/adapter.

According to another particular feature, the enclosure includes a safety valve.

According to another particular feature, the tank is distanced from the walls of the enclosure by perforated supports to allow run-off of the condensed water.

Other particular features and advantages of the disclosed embodiments will appear more clearly on reading the description that follows with reference to the appended drawings in which:

### BRIEF DESCRIPTION OF THE DRAWINGS

FIG. 1 represents a view in longitudinal section of one embodiment of the device;

FIG. 2 represents a view in longitudinal section of another embodiment of the device.

FIG. 3 represents a view in cross section of the embodiment represented in FIG. 2.

### DETAILED DESCRIPTION OF THE DRAWINGS

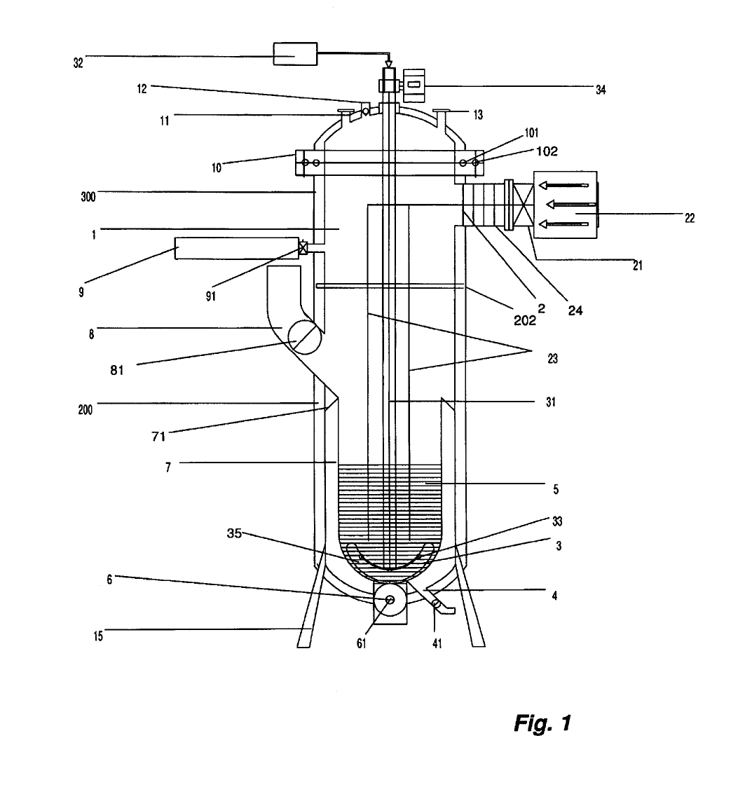

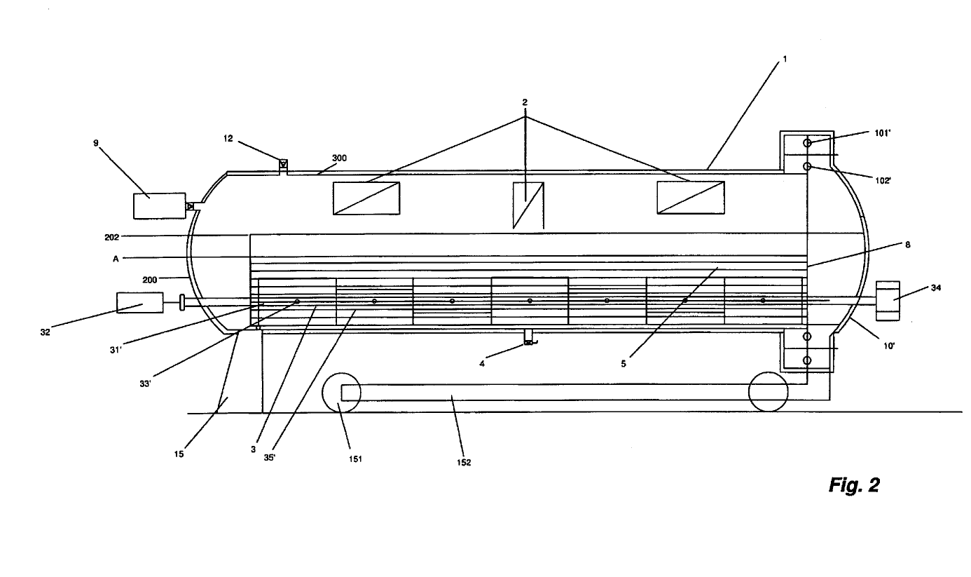

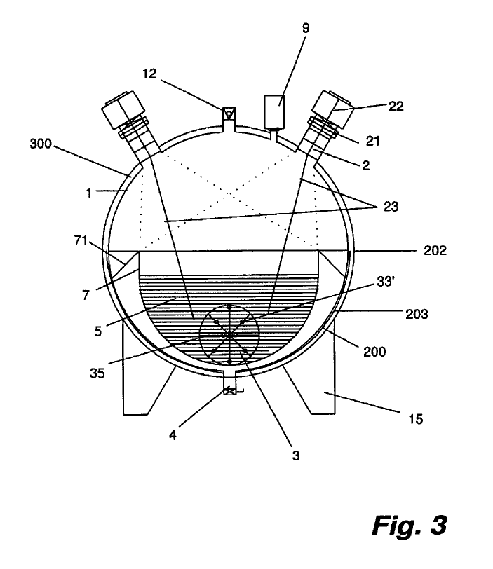

As shown in FIGS. 1, 2 and 3, the device is composed of an enclosure (1), preferably cylindrical and of elongated shape in a metallic material with a double wall that provides firstly, both good thermal insulation and sealing against the pressure of the steam, and secondly, sealing against the microwaves. This enclosure (1) includes at least one end that is open to the outside and capable of being closed off by a door (10) or a lid (10). In a preferred embodiment, the enclosure (1) includes one end that can be closed off. The door (10) that is used to close off the openings is designed so that the enclosure (1) is totally hermetic to the air, to the steam pressure, and to waves such as microwaves, when the door (10) is closed. The door (10) therefore includes a Teflon or silicone gasket (102) for sealing against the pressure, and a metal gasket (101) for sealing against the microwaves. In the embodiment represented in FIG. 2, the door (10) is able to slide by virtue of a movement system (152) that includes wheels (151) connected to the door. This system thus allows the door to be moved axially in relation to the enclosure (1). In this embodiment, the sludge is loaded via the opening formed when the door is open.

In general, the enclosure (1) rests on the ground, and is held in place by feet (15), with the part resting on the ground forming the bottom part of the enclosure (1).

On the inside, the enclosure (1) includes an additional wall in its bottom part, forming a spherical tank (7) into which the sludge (5) to be dried will be loaded. This tank (7) includes upper ridges (71) attached to the enclosure (1) and in which small openings are formed. These openings allow the removal toward the bottom of the enclosure (1) of the water condensed on the internal wall of the enclosure (1).

In the embodiment represented in FIG. 1, the material (5) to be dried is loaded into the enclosure (1) via a material input (8). This arrival point (8) is positioned on one face of the enclosure (1), at mid-height on the latter.

In the embodiment represented in FIG. 2, the loading of the material (5) to be dried is achieved by virtue of the tank which, being positioned on a travelling trolley (151, 152), can be moved laterally, with the unloading being achieved by tipping the tank.

The sludges (5) treated by the disclosed embodiments are of a nature such as sewage sludges, liquid manure, the output from septic tanks, etc.

The enclosure (1) also includes at least one rounded or rectangular opening (2) constituting a window (2). In one embodiment, the enclosure (1) includes several windows (2). These windows (2) are made from a material that is sealed against steam but which allows the microwave radiation to pass. In one embodiment, the windows (2) are in quartz crystal. In another embodiment the windows (2) are in Teflon, or any other material that allows the passage of electromagnetic radiation and sealing against the steam. These pressurised windows (2) are used to send the microwaves (23) toward the interior of the enclosure (1) and are called transmitting windows (2). They thus allow the microwaves (23) to pass, which then act upon the sludge (5) to be dried. The microwaves (23) are conveyed by a waveguide (24) to at least one window (2). The waveguide (24) communicates through an impedance coupler/adapter (21) and the microwave generator (22). The wave generator (22, 23) is thus used to treat the sludge (5) to be dried. The windows (2) are positioned in the top part of the enclosure (1) meaning the part opposite to the one that rests on the ground.

In a first embodiment represented in FIG. 1, the enclosure (1) is vertical. In this case it is more high than wide. In this embodiment the enclosure (1) includes an opening at the end opposite to that resting on the ground. The windows (2) are then positioned on the top part, below the opening, and therefore underneath the lid (10). In this case, as they exit through the windows, the microwaves are perpendicular in relation to the bottom of the tank, and are then redirected so as to arrive vertically in the material (5) to be dried.

In another embodiment, the windows (2) are positioned on the lid (10), and thus allow direct radiation, which arrives vertically in the material (5) to be dried.

In a second embodiment represented in FIG. 2, the tank is positioned horizontally; it is then more wide than high. In this case the opening, which is still at one end, will be positioned on the side opposite to the power supply. The windows (2) are then still positioned in the top part of the enclosure (1), meaning in the part opposite to that resting on the ground.

Whatever the embodiment, when the windows (2) are rectangular, they are positioned so as to be inverted in relation to each other, meaning that one window is positioned in the direction of the length, and that alongside in the direction of the height, etc., as illustrated in FIG. 2.

The enclosure (1) is in communication via at least two pipes with at least two steam-generating systems.

A first generator (9) produces saturating steam. This steam is injected into all of the enclosure (1) before loading the material (5) to be dried.

A second generator (32) produces superheated steam. This superheated steam is injected directly into the material (5) to be dried.

A mixer (3) is placed inside the enclosure (1). This mixer (3) is formed from a tube (31, 31′) that passes through the enclosure (1). This tube (31, 31′) is connected to the superheated steam generator (32). The tube (31, 31′) includes at least one mixer element (35, 35′). This mixer element (35, 35′) is in possession of means (33, 33′) for the injection of the superheated steam. The injection means (33, 33′) are formed by openings (33, 33) formed on the mixer element (35, 35′). The steam produced by the generator (32) flows in the tube until it arrives at the mixer element (35, 35′), and is then injected by the injection means (33, 33′) to the centre of the material (5) to be dried.

In the first embodiment, the mixer element (35) is formed by vanes attached to the end of the tube (31) arriving at the bottom of the enclosure (1). The mixer turns by virtue of a motor (34) placed outside the enclosure (1). The vanes follow the spherical or elliptical shape of the bottom of the tank (7).

The tube is offset in relation to the axis (A) of symmetry of the tank, meaning close to the wall away from the microwave source.

In the second embodiment, the mixer element (35′) is formed by rectangular vanes attached to the periphery of the tube (31′), preferably in a helical geometry and mutually offset. The tube rotates by virtue of a motor (34), and behaves as an endless screw.

In both cases, the vanes are fixed so as to arrive as close as possible to the bottom of the tank (7) so as to mix a maximum of the material (5) to be dried. The material used for the vanes is a material that is resistant to microwaves. The material can be Pyrex or Teflon for example.

The vanes are fixed so as not to pass beyond the material (5) to be dried before drying, and the quantity of material (5) is chosen so that, at the end of the drying process, the vanes do not project excessively, in order to avoid problems due to the impact of the microwaves.

The role of the mixers is firstly to mix the sludge (5) so as to achieve homogeneous drying, and secondly to increase the penetration of the microwaves into the sludge (5) and favour the drying process. In fact with no mixing of the sludge, a dry crust is formed rapidly at its surface, preventing correct penetration of the microwaves, and therefore inhabits effective and homogeneous drying.

The condensation water is removed via a pipe (4) that is controlled by a water-removal valve (41) and positioned in the bottom part of the enclosure.

This water removal valve (41) is used to keep the enclosure (1) at the desired pressure, to remove pressure if the latter is too high, and finally to open the enclosure (1) to the atmosphere when the drying process is complete.

The top part of the enclosure (1) includes a safety valve (12) that is set according to the wanted pressure, and which will operate only in the event of an incident requiring the pressure to be adjusted other than with the water removal valve (41). This valve (12) is therefore never used in the normal operation of the device.

The enclosure (1) also includes refrigerating means (203) in its double wall. These refrigerating means (203) are placed so as to allow cooling of the bottom part of the enclosure (1), and thus condensation of the evaporation water. The refrigerating means (203) can be coils for example, in which a coolant gas flows.

These cooling means (203) form a cold zone (200) and a hot zone (300) in the enclosure. The separation (202) between the two zones is located at between half and three quarters from the bottom part of the enclosure.

In its bottom part, the enclosure (1) includes a door (6) that is used to remove the dried material when the drying cycle has ended. In the embodiment represented in FIG. 1, this door (6) also includes a guide that will allow the mixer (3) to be kept straight, and stop it from tipping over during the mixing process.

The enclosure (1) includes means (11) to measure the temperature and pressure in order to regulate these parameters during drying.

The opening assembly of the enclosure (1) includes a valve system (91, 81, 61, 41) that allows the enclosure (1) to remain hermetic, and so to prevent leakage of the microwaves.

All of the pressures and temperatures used in the context of the disclosed embodiments are calculated in particular from the Mollier diagram.

The drying method employing the device just described includes the following operations:

pressurisation of the enclosure (1) by sending saturating steam into the enclosure (1) until the pressure corresponding to the desired operating temperature of the saturating steam is reached. For example, it is possible to choose a pressure of 1 bar for a temperature of 100° Celsius. of the saturating steam, to 3 bars for a temperature of 130° Celsius. of the saturating steam.

introduction of the material (5) to be dried, which is in the form of a sludge. At this stage, the sludge (5) includes between 70% and 80% of water;

sending of the superheated steam, by means of the tube (31, 31′) and of the mixer elements (35, 35′), to the centre of the sludge (5) to be dried, while simultaneously mixing it. Mixing is very important since it allows uniform drying. The superheated steam is injected at a pressure of 1 bar to 5 bars, and at 3 bars in one embodiment. This results in a temperature of the sludge (5) in the neighbourhood of 130° C. This stage is used to effect pre-drying of the material.

when the temperature reaches 130° C., transmission of the microwaves in order to accelerate drying of the material. The wavelength of the microwaves is between 400 and 2450 MHz.

There is therefore a pressure difference between the top part of the enclosure (1) and the bottom part of the enclosure (1) where the sludge (5) is located. This pressure differential will favour the removal of the water toward the exterior of the sludge (5). The power of the microwave generators is calculated so as to reach a sludge temperature (5) above that of the saturating steam.

In the presence of a saturating steam pressure, the humidity released by the sludge during its treatment will therefore run off via the cold walls, by gravity, to be recovered below the grill (71) via the water removal valve (41). Opening of this valve (41) is triggered at regular intervals by the monitoring system whenever the level approaches the grill. The enclosure (1) includes a level-detecting device that allows automatic opening of the valve (41).

After a certain time, when the sludge is dried, the microwave generator is also stopped, and the pressure is reduced so as to arrive progressively at atmospheric pressure.

By the raising to saturation of the ambient environment around the sludge (5), and the judicious use of microwave power, with energy consumption that is much less than those generally used in the prior art, it is possible to accelerate the process for removal of the humidity inside the sludge (5) and to achieve faster drying, with a lower consumption of energy.

In addition, working under a saturating pressure eliminates explosive phenomena by preventing the presence of oxygen.

It should be obvious to those practised in the art that the disclosed embodiments allow embodiments in many other specific forms without moving outside the scope of the disclosed embodiments as claimed. As a consequence, the present embodiments should be seen as illustrations only, but which can be modified within the area described by the scope of the attached claims, and the disclosed embodiments must not be limited to the details given above.

1. A method for the drying of sludges such as sewage sludges, liquid manure, or the output from septic tanks, by irradiation with microwaves, wherein the sludge drying method includes:
a stage for the raising of a sealed enclosure to a set pressure, at least by the injection of saturating water vapour, and for holding this pressure for a given length of time;
a stage for loading the sludges into a tank that is distanced from the walls of the enclosure, with loading means that guarantee maintenance of the pressure;
a stage for the injection of superheated steam into the sludge by means of a mixer in action close to the wall of the tank that is most distant in relation to the source of the microwaves, including injection means;
a stage for heating to the centre of the sludge by the emission of microwaves at frequencies of between 400 and 2450 MHz in the direction of the tank, this stage being executed while mixing the sludge;
a stage for removal of the water collected by condensation and run-off on the walls of the enclosure toward the bottom of the enclosure, by means of a valve leading to the outside.

2. A drying method according to claim 1, wherein during the whole drying period, the sludge is mixed with the mixer in order to achieve greater homogeneity of the drying process, while also considerably favouring the penetration of the microwaves into the material.

3. A drying method according to claim 1, wherein the water vapour saturating pressure is in a range between 1 bar and 3 bars.

4. A drying method according to claim 1, wherein the water vapour saturating pressure is 1 bar.

5. A drying method according to claim 1, wherein the superheated steam pressure is between 1 bar and 5 bars.

6. A drying method according to claim 5, wherein the superheated steam pressure is 3 bars.

7. A drying method according to claim 1, wherein the temperature of the enclosure must be less than the temperature of the sludge, in order to allow evaporation.

8. A drying method according to claim 1, wherein irradiation by the microwaves is effected when the temperature of the sludge is between 110° C. and 140° C.

9. A drying method according to claim 1, wherein irradiation by the microwaves is effected when the temperature of the sludge is 130° C.

10. A device comprising an enclosure, including a sealed tank, that is resistant to pressure and communicates via at least one window in quartz crystal or any other material suitable for use with microwaves, with at least one microwave generator, where the enclosure communicates with a saturating steam generator and an input of sludge to be dried, a mixer including means for the injection of superheated steam, placed in the enclosure, and a door for unloading dried sludges.

11. A device according to claim 10, wherein it includes, in its lowest part, oriented toward the ground, an orifice that is used to remove the run-off water, by gravity, controlled by a water removal valve, or to regulate the internal pressure of the enclosure.

12. A device according to claim 10, wherein the enclosure includes refrigerating means placed at its lowest part, so as to cool its internal wall in contact with the pressurised atmosphere, with these means being placed so as to cool only part of the enclosure.

13. A device according to claim 10, wherein the refrigerating means are used to cool between half and three quarters of the enclosure.

14. A device according to claim 10, wherein the mixer is formed from a tube that includes at least one mixer element of the vane type attached to its periphery, with the injection means being placed on this element.

15. A device according to claim 10, wherein the tube is connected to a superheated steam generator, with the steam produced by the generator flowing in the tube until it arrives at the mixer element, then being injected by the injection means.

16. A device according to claim 10, wherein the injection means are formed by openings formed on the mixer element.

17. A device according to claim 10 wherein all the openings of the enclosure are capable of being plugged by plugging means in order to set up sealing conditions against the pressure and the microwaves.

18. A device according to claim 10, wherein the enclosure includes refrigerating means that are used to cool a part of its inside surface in order to favour the condensation of the water evaporated by the drying treatment.

19. A device according to claim 10, wherein it includes at least one end that can be closed off by an automatic door, to set up the sealing conditions against the pressure and the microwaves.

20. A device according to claim 10, wherein the microwave generator communicates with the drying enclosure through a microwave coupler/adapter.

21. A device according to claims 10, wherein the enclosure includes a safety valve.

22. A device according to claim 10, wherein the tank is distanced from the walls of the enclosure by perforated supports, in order to allow run-off of the condensed water.
